(19) United States
(12) Patent Application Publication
(10) Pub. No.: US 2023/0085503 A1
(43) Pub. Date: Mar. 16, 2023

(54) RESOURCE DISTRIBUTION DEVICE, RESOURCE DISTRIBUTION METHOD, AND RESOURCE DISTRIBUTION PROGRAM

(71) Applicant: NIPPON TELEGRAPH AND TELEPHONE CORPORATION, Tokyo (JP)

(72) Inventors: Miho IKEDA, Tokyo (JP); Naoko KOSAKA, Tokyo (JP); Tomohiro KOKOGAWA, Tokyo (JP)

(73) Assignee: NIPPON TELEGRAPH AND TELEPHONE CORPORATION, Tokyo (JP)

(21) Appl. No.: 17/794,223

(22) PCT Filed: Jan. 28, 2020
(86) PCT No.: PCT/JP2020/003044

§ 371 Date: Jul. 20, 2022

(51) Int. Cl. G06Q 10/06

(52) U.S. Cl. CPC G06Q 10/06313; G06Q 10/06315

(57) ABSTRACT

A resource distribution calculation device (10) decides resources required to recover a project in which a failure occurs. The resource distribution calculation device (10) then calculates the quantity of excess resources for another project in which no failure occurs. The resource distribution calculation device (10) then outputs information regarding excess resources distributable to the project in which the failure occurs based on the calculated excess resources.

### TECHNICAL FIELD

The present invention relates to a resource distribution calculation device, a resource distribution calculation method and a resource distribution calculation program.

### BACKGROUND ART

Organizations such as companies and government and municipal offices operate projects for producing or providing products and services. When an incident occurs, which is an event where an element for realizing a project such as equipment or a site is damaged such as due to a natural disaster or cyberattack, tasks utilizing the element are delayed or stopped, and the service level of the project falls below a level expected from the society or a level set as objective by the organization.

When an incident occurs, a plurality of elements may be damaged simultaneously. In order to reduce the damage to the organization as a whole and achieve early recovery, it is necessary to prioritize issues to be responded to from the viewpoint of importance for the project and dispose limited resources in an efficient and effective manner. Business continuity planning is known as a method for quickly making such determinations (for example, see Non-Patent Literature 1).

### CITATION LIST

### Non-Patent Literature

Non-Patent Literature 1: “Business Continuity Guidelines—Strategies and Responses for Surviving Critical Incidents—”, [online], Cabinet Office, [Retrieved on Jan. 20, 2020], <http://www.bousai.go.jp/kyoiku/kigyou/pdf/guideline03.pdf>

### SUMMARY OF THE INVENTION

### Technical Problem

However, the conventional technique mentioned above has a problem of incapability of appropriately distributing resources when an incident occurs. For example, the business continuity plan mentioned above is formulated by procedures of formulating basic policies, analyzing and evaluating the degree of impact on the project and risk, and considering business continuity strategies and responses. Specific procedures of analyzing the degree of impact on the project include procedures of evaluating the degree of impact due to suspension of the project, setting an objective recovery time and an objective recovery level by narrowing down important tasks to be continued and recovered with higher priority based on the result, recognizing important elements essential to carry out each important task, and extracting a bottleneck.

Specific procedures of analyzing the risk include procedures of identifying occurrence events that may cause a suspension of the project, evaluating the possibility of occurrence of those events and the degree of impact in case that those events occur to narrow down occurrence events to be responded to with higher priority, considering damages caused by the occurrence events to the important tasks selected in the analysis of the degree of impact on the project, and estimating an objective recovery time and an objective recovery level.

In accordance with the conventional technique, when an incident occurs, the situation at the time of occurrence of the incident and the contents of the business continuity plan are compared to discriminate whether a damaged element is related to an important task, and then, an objective recovery time and an objective recovery level are referenced to determine the priority order of responses and associated resource distribution.

However, only limited resources are then available to the organization, and thus, it may be necessary to rent resources assigned to a task that is not damaged due to the occurrence of the incident in order to achieve the objective recovery time and the objective recovery level. If a choice of lending resources is made in this case, the objective recovery time and the objective recovery level can be achieved, whereas the service level of the task for which resources are lent is decreased.

### Means for Solving the Problem

In order to solve the problem described above and achieve the object, a resource distribution calculation device of the present invention includes a decision unit that decides resources required to recover a project in which a failure occurs, a calculation unit that calculates a quantity of excess resources for another project in which no failure occurs, and an output unit that outputs information regarding resources distributable to the project in which the failure occurs based on the excess resources calculated by the calculation unit.

### Effects of the Invention

The present invention achieves an effect that resources can be appropriately distributed when an incident occurs.

### BRIEF DESCRIPTION OF DRAWINGS

FIG. 1 is a diagram for illustrating a configuration of a system including a resource distribution calculation device according to a first embodiment.

FIG. 2 is a diagram showing an example of projects, a task process list and a task flowchart.

FIG. 3 is a diagram showing an example of a task flowchart and a required resource definition list.

FIG. 4 is a diagram showing an example of a task support system flowchart and a task support system list.

FIG. 5 is a diagram showing example data regarding sales management in a budget control list.

FIG. 6 is a diagram showing example data regarding operation management in the budget control list.

FIG. 7 is a diagram showing example data regarding state outlines of resources in a resource management list.

FIG. 8 is a diagram showing example data regarding state details of resources in the resource management list.

FIG. 9 is a diagram illustrating association of elements.

FIG. 10 is a diagram showing an example of a business continuity plan.

FIG. 11 is a diagram showing an example of provisional response procedures and recovery procedures.

FIG. 12 is a flow chart showing an example processing flow of the resource distribution calculation device according to the first embodiment.

FIG. 13 is a diagram showing an example of processing results of steps.

FIG. 14 is a diagram illustrating a resource provision calculation process in consideration of trade-offs.

FIG. 15 is a diagram showing example output data.

FIG. 16 is a diagram showing a computer that executes a resource distribution calculation program.

### DESCRIPTION OF EMBODIMENTS

An embodiment of a resource distribution calculation device, a resource distribution calculation method and a resource distribution calculation program according to the present application will be described in detail below based on the drawings. Note that the resource distribution calculation device, the resource distribution calculation method and the resource distribution calculation program according to the present application are not limited to the embodiment.

### First Embodiment

In the following embodiment, a configuration of a system 1 including a resource distribution calculation device 10 and a processing flow of a resource distribution calculation device 10 according to a first embodiment will be described in order, and effects of the first embodiment will be described lastly.

[Configuration of Resource Distribution Calculation Device]

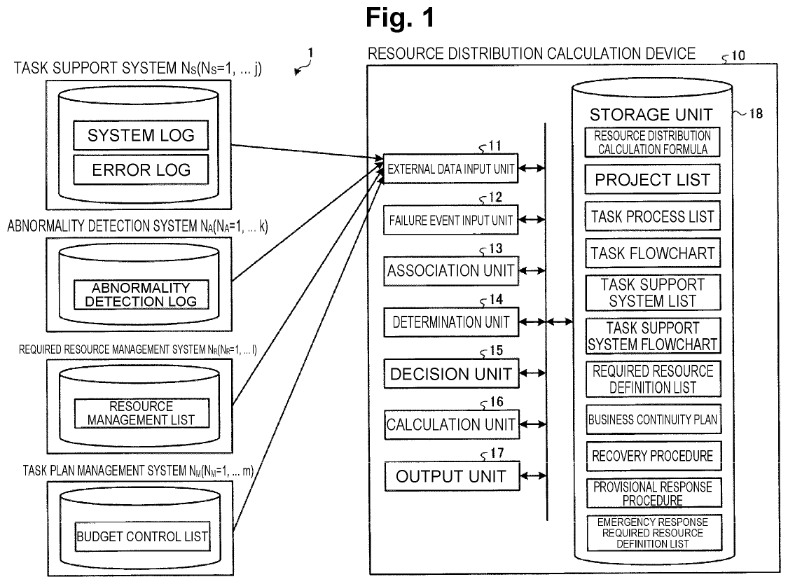

FIG. 1 is a diagram for illustrating a configuration of the system including the resource distribution calculation device according to the first embodiment. As illustrated in FIG. 1, the resource distribution calculation device 10 of the present embodiment performs a resource distribution calculation process, which will be described later, by using information of a plurality of task support systems N_{S} (N_{S}=1, . . . , j), a plurality of abnormality detection systems N_{A} (N_{A}=1, . . . , k), a plurality of required resource management systems N_{R} (N_{R}=1, . . . , l) and a plurality of task plan management systems N_{M} (N_{M}=1, . . . , m). Here, j, k, l and m may be numerical values different from each other.

The resource distribution calculation device 10 is a server device, for example. The resource distribution calculation device 10 decides resources required to recover a project in which a failure occurs, calculates the quantity of excess resources for another project in which no failure occurs, and outputs information regarding excess resources distributable to the project in which the failure occurs based on the calculated excess resources.

When an incident occurs, the resource distribution calculation device 10 can compare a damage condition of the incident, an objective recovery level and the degree of impact on the project and effectively distribute resources in order to support appropriately distributing resources among damaged tasks and tasks not damaged.

The task support systems N_{S} are IT systems used to perform tasks in an organization carrying out projects. Each task support system N_{S} stores a system log and an error log. The system log is an operation history of the task support system N_{S}. The error log includes failure information indicating which task function of the task support system N_{S} is in an abnormal state when an abnormality occurs.

The abnormality detection systems N_{A} are systems for detecting abnormalities in the task support systems N_{S}. One or more abnormality detection systems N_{A} correspond to each or a plurality of task support systems N_{S}. Each abnormality detection system N_{A} stores an abnormality detection log that is a history of cases of detecting abnormalities in the respective target task support system N_{S}. The abnormality detection log includes failure information indicating which task function of the target task support system N_{S} is in an abnormal state.

The required resource management systems N_{R} are systems for managing resources required for each project. One or more required resource management systems N_{R} correspond to each or a plurality of task support systems N_{S}. Each required resource management system N_{R} stores a resource management list including information on resources required to perform each task procedure. The resource management list includes a listing of usage conditions, the remaining number or the like of resources required to perform each task procedure.

The task plan management systems N_{M} are systems for managing plans and actual results of projects, task processes and task procedures in the organization carrying out the projects. Each task plan management system N_{M} stores a budget control list. The budget control list includes a listing of plans and actual results of projects, task processes and task procedures.

In addition, as shown in FIG. 1, the resource distribution calculation device 10 includes an external data input unit 11, a failure event input unit 12, an association unit 13, a determination unit 14, a decision unit 15, a calculation unit 16, an output unit 17 and a storage unit 18.

The storage unit 18 is realized by a semiconductor memory device such as a random access memory (RAM) or a flash memory or a storage device such as a hard disk or an optical disc.

In the present embodiment, the storage unit 18 stores a resource distribution calculation formula, a project list, a paperwork process list, a task flowchart, a task support system list, a task support system flowchart, a required resource definition list, a business continuity plan, a recovery procedure, a provisional response procedure and an emergency response required resource definition list.

These pieces of information are collected from the task support systems N_{S} or the like prior to the resource distribution calculation process, which will be described later, and are stored in the storage unit 18. Note that these various pieces of information are not necessarily stored in the storage unit 18 of the resource distribution calculation device 10 and may also be collected when the resource distribution calculation process, which will be described later, is performed, for example.

The resource distribution calculation formula is a calculation formula for calculating resources required to perform response measures required to achieve each objective recovery time and objective recovery level. The project list is a listing of all tasks performed by the organization.

The task process list is a listing of task processes constituting each project. The task flowchart is a listing in which task procedures of each task process are described. The task support system list is a listing of systems used for each task process.

The task support system flowchart is a listing in which task support systems N_{S} used for each task procedure of each task process and task functions of the task support systems N_{S} are described. The required resource definition list is a listing in which resources required to perform each task procedure once are described. It is assumed here that the “required resource definition list” describes required resources per unit and the “required resources” describes the number of resources actually required (resources derived by unit x the number of performances of the task procedure).

The business continuity plan is information indicating an objective recovery level and an objective recovery time and response measures, response frameworks and response procedures for reaching the objective recovery level in the case of the occurrence of an incident. The recovery procedure is information indicating matters to be performed to completely recover the service level to a regular normal level and the order of performing them.

The provisional response procedure is information indicating a stepwise objective recovery level, matters required to be performed to achieve the stepwise objective recovery level in the course of reaching the complete recovery of the service level and the order of performing them. The emergency response required resource definition list is a listing in which resources required to perform the recovery procedure and the provisional response procedure are described. It is assumed here that the “emergency response required resource definition list” refers to the number of resources actually required, in contrast to the “required resource definition list”.

The external data input unit 11 is an interface for importing, into the resource distribution calculation device 10, data from an external system or external storage medium, such as the system log and the error log output from the task support system N_{S}, the abnormality detection log output from the abnormality detection system N_{A}, the resource management list output from the required resource management system N_{R}, and the budget control list output from the task plan management system N_{M}.

The failure event input unit 12 is an interface that enables manual input of damage conditions of projects, tasks and the like due to the occurrence of an incident.

The association unit 13 performs association of projects, task processes, task procedures and required resources, and then performs association of required resources and resource conditions. The association unit 13 also performs association of the business continuity plan, emergency responses and emergency response required resources.

[Association of Projects, Task Processes, Task Procedures And Required Resources]

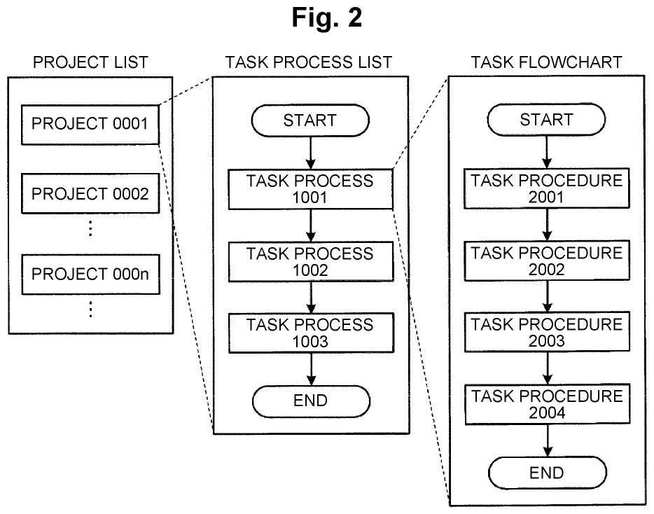

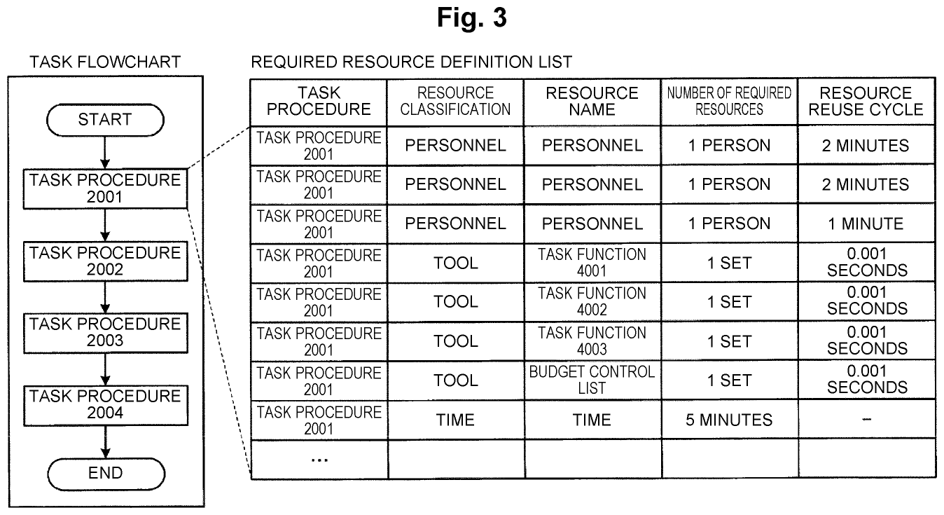

The process of associating projects, task processes, task procedures and required resources will now be described by using the example of FIGS. 2 and 3. FIG. 2 is a diagram showing an example of projects, the task process list and the task flowchart. FIG. 3 is a diagram showing an example of the task flowchart and the required resource definition list.

As illustrated in FIG. 2, it is assumed that the project list records a listing of projects. It is assumed that the task process list records a listing in which each project and a group of task processes constituting each project are associated, task processes constituting each group of task processes and their order relationship.

It is assumed that the task flowchart records a listing in which each task process and a group of task procedures constituting each task process are associated, task procedures constituting each group of task procedures and their order relationship.

In addition, as illustrated in FIG. 3, the required resource definition list records resource classifications (examples: personnel, tool, time and the like), resource names, the numbers of required resources, resource reuse cycles and the like required to realize each task procedure. Note that the required resource definition list may also record specifications of resources (such as skills required for personnel and specifications required for equipment) and the like.

It is assumed that element names and element IDs are defined for elements included in each list and each flow chart so that they can be uniquely identified. In addition, element names and element IDs may similarly be defined for a group of task processes constituting each project and a group of task procedures constituting each task process so that they can be uniquely identified.

For example, the association unit 13 retrieves the resource distribution calculation formula from the storage unit 18, and receives the project list, the task process list, the task flowchart and the required resource definition list as inputs to associate elements included in each list and each flow chart based on the element names and element IDs. Thus, the association unit 13 associates the elements over the lists and flow charts, such as “project task process task procedure⇔required resource”.

By performing this association, the resource distribution calculation device 10 can calculate resources required to perform a certain task procedure once. In addition, the resource distribution calculation device 10 can use the result of this calculation to calculate a subtotal and total quantity of resources required to realize a project, task process or task procedure if the number of repetitions of each task process required to realize the project or the number of repetitions of each task procedure required to perform each task process is defined in the project list, the task process list and the task flowchart.

[Association of Required Resources and Resource Conditions]

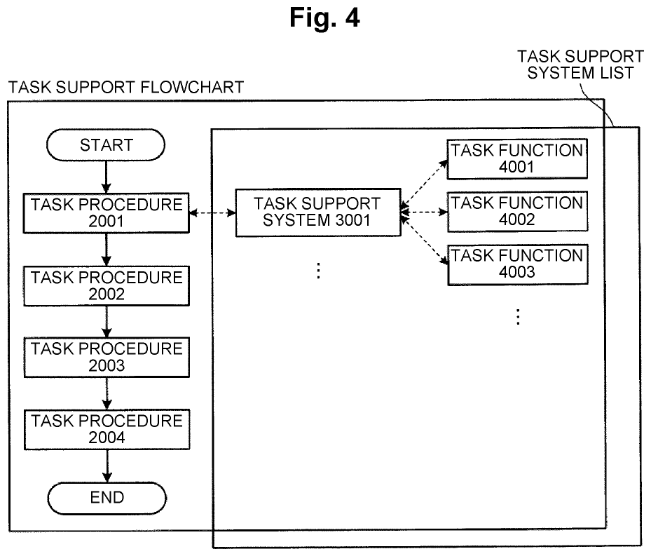

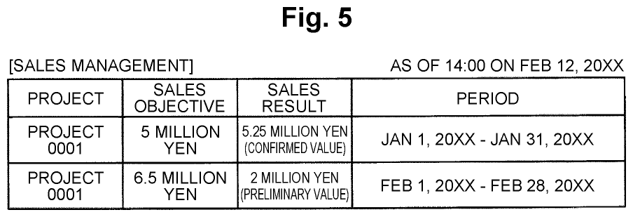

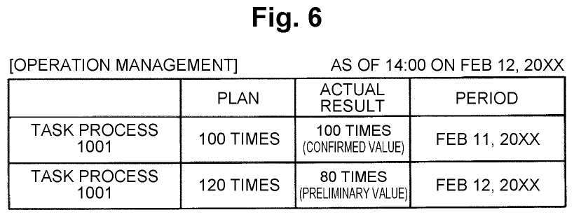

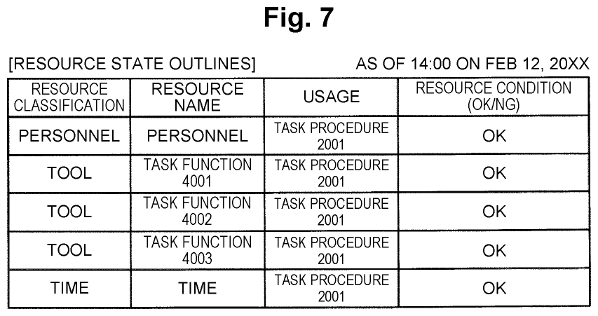

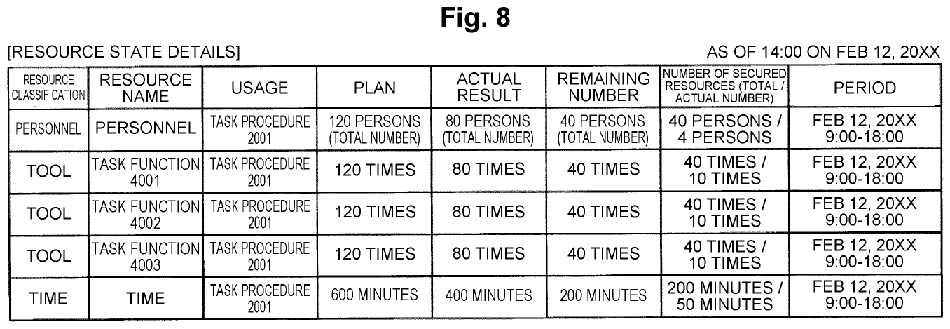

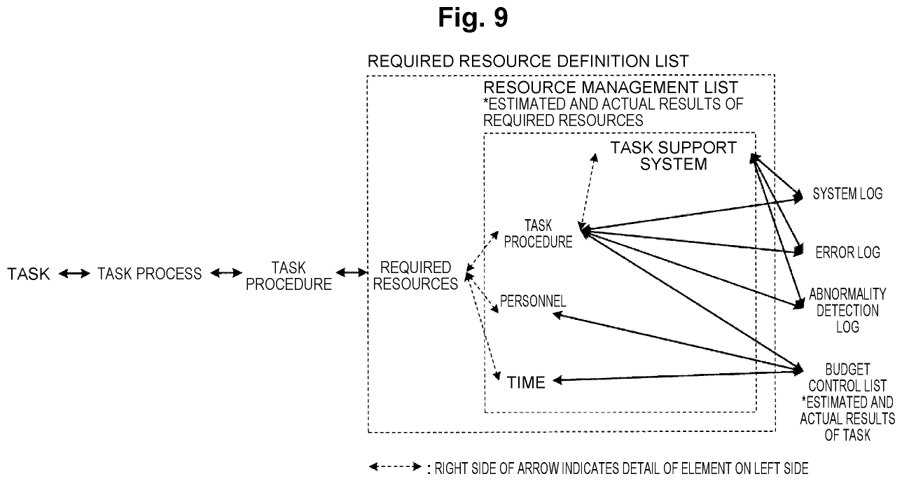

The process of associating projects, task processes, task procedures and required resources will be described by using the example of FIGS. 4 and 9. FIG. 4 is a diagram showing an example of the task support system flowchart and the task support system list. FIG. 5 is a diagram showing example data regarding sales management in the budget control list. FIG. 6 is a diagram showing example data regarding operation management in the budget control list. FIG. 7 is a diagram showing example data regarding state outlines of resources in the resource management list. FIG. 8 is a diagram showing example data regarding state details of resources in the resource management list. FIG. 9 is a diagram illustrating association of elements.

As illustrated in FIG. 4, it is assumed that the task support system list records a listing in which task support systems used for each task procedure and task functions provided by each task support system N_{S} are associated. In addition, it is assumed that the task support system flowchart records a listing in which task procedures, task support systems N_{S} used for each task procedure and task functions of each task support system N_{S} are associated.

It is assumed that the system logs and the error logs of the task support systems and the abnormality detection logs of the abnormality detection systems include element names and element IDs for uniquely identifying the task support systems and task functions so that it is possible to determine which task support system or task function a certain log is related to.

In addition, it is assumed that the budget control list records plans and actual results of a performance period, the number of performances and the like of each project, each task process and each task procedure. For example, as illustrated in FIG. 5, the budget control list records an objective and an actual result of sales of each project in a certain period. In addition, for example, as illustrated in FIG. 6, the budget control list records a plan and an actual result of the number of performances of each task process in a certain period and a plan and an actual result of the number of performances of each task procedure in a certain period.

It is assumed that the resource management list records state outlines of resources required to realize each task procedure, state details of the resources and the like as planned in the budget control list.

It is assumed that, in the state outlines of resources, normality/abnormality (OK/NG) or the like is determined by comparing the remaining number of resources required for a certain period and secured resources for personnel and time as illustrated in FIG. 7, for example. It is assumed that, for tools, normality/abnormality or the like is determined based on element names and element IDs included in the system log, error log and abnormality detection log.

In addition, for example, when it is planned to perform a task procedure 2001 120 times on a certain date as illustrated in FIG. 8, the state details of resources correspond to planned values of required resources and actual result values of resources spent until the present point of time, the remaining number of resources required for the remaining number of performances and the number of secured resources. Note that the example of FIG. 8 is an element used to perform the determination of the resource conditions in the example of FIG. 7.

It is assumed that element names and element IDs are defined for elements included in each list and each flow chart so that they can be uniquely identified. The association unit 13 retrieves the resource distribution calculation formula from the storage unit 18, and receives the results of the process of associating the projects, task processes, task procedures and required resources described above, the required resource definition list, the task support system list, the task support system flowchart, and the system log, the error log, the abnormality detection log, the budget control list and the resource management list imported by the external data input unit as inputs to associate elements included in each list, each flow chart and the like based on element names and element IDs. Thus, the association unit 13 can associate the elements over the lists and the flow charts in the following manner as illustrated in FIG. 9. “project⇔task process⇔task procedure⇔required resource⇔resource condition⇔system log, error log, abnormality detection log, budget control list”

[Association of Business Continuity Plan, Emergency Responses and Emergency Response Required Resources]

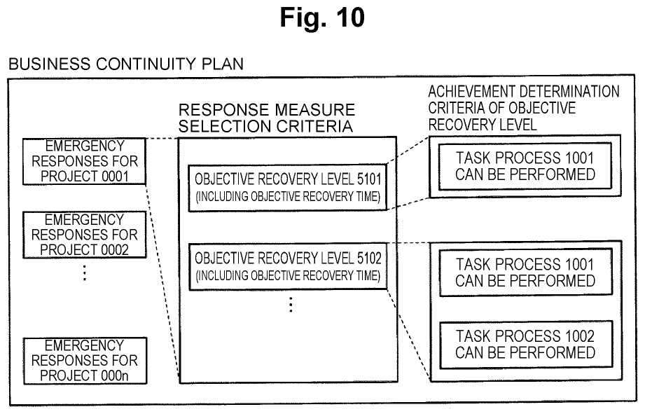

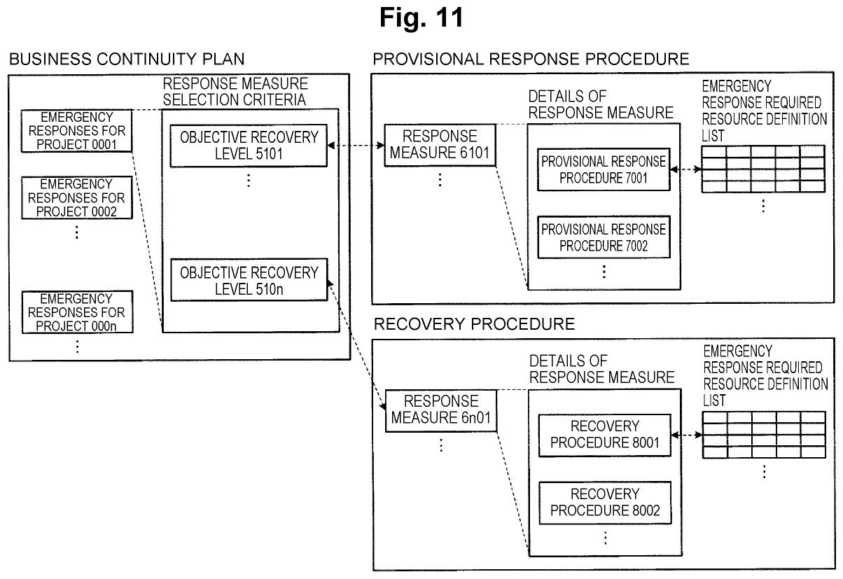

The process of associating the business continuity plan, various procedures of emergency response and resources required to perform the various procedures will be described by using the example of FIGS. 10 and 11. FIG. 10 is a diagram showing an example of the business continuity plan. FIG. 11 is a diagram showing an example of provisional response procedures and recovery procedures.

As illustrated in FIG. 10, it is assumed that the business continuity plan records a listing in which emergency responses of each project, objective recovery levels of each project and objective recovery times thereof are associated and a listing in which the objective recovery levels and their achievement determination criteria are associated. Note that it is assumed that absolute or relative priority is defined for each objective recovery level of each project based on the degree of importance of each project.

In addition, as illustrated in FIG. 11, it is assumed that the provisional response procedure records a listing of response measures associated with the objective recovery levels defined by the business continuity plan and a listing in which the response measures and provisional response procedures constituting each response measure are associated. It may also include a listing in which each provisional response procedure and the emergency response required resource definition list, which will be described later, are associated.

In addition, as illustrated in FIG. 11, it is assumed that the recovery procedure records a listing of response measures associated with the objective recovery levels defined by the business continuity plan and a listing in which the response measures and recovery procedures constituting each response measure are associated. It may also include a listing in which each recovery procedure and the emergency response required resource definition list, which will be described later, are associated.

It is assumed that the emergency response required resource definition list records resource classifications (examples: personnel, tool, time and the like), resource names, the numbers of required resources and resource reuse cycles required to realize various procedures at the time of an emergency. It is assumed that element names and element IDs are defined for elements included in each list and each procedure so that they can be uniquely identified.

The association unit 13 retrieves the resource distribution calculation formula, and receives the business continuity plan, the provisional response procedure, the recovery procedure and the emergency response required resource definition list as inputs to associate elements included in each list and each procedure based on element names and element IDs, thereby associating the elements over the lists and procedures such as “objective recovery level response measure response measure details (provisional response procedure, recovery procedure)⇔emergency response required resource”. By performing this association, the association unit 13 can calculate procedures required to realize a certain objective recovery level, a subtotal of resources required to realize the procedure and the total quantity of resources required as a whole.

The determination unit 14 determines a project in which a failure occurs. For example, the determination unit 14 determines a failure occurrence point by receiving the system log or error log output from the task support system N_{S}, the abnormality detection log output from the abnormality detection system N_{A}, or failure information input to the failure event input unit 12. It is assumed here that the failure information input to the failure event input unit 12 is information indicating that a resource condition managed in the resource management list is an abnormality. Note that the value of the “resource condition” as a determination result may be input, or, to obtain higher accuracy, each element used for determination of the resource condition as shown in FIG. 8 may be input as the failure information.

The decision unit 15 decides resources required to recover a project in which a failure occurs. Specifically, the decision unit 15 decides resources required to recover the project in which the failure occurs determined by the determination unit 14.

The calculation unit 16 calculates the quantity of excess resources for another project in which no failure occurs. In addition, when there are a plurality of other projects in which no failure occurs, the calculation unit 16 may calculate the quantity of excess resources for each of the plurality of other projects and decide, as excess resources distributable with higher priority, excess resources for another project with the largest quantity of excess resources of the calculated excess resources.

In addition, when there is no excess resources for other projects, the calculation unit 16 may calculate, for each of other projects in which no failure occurs, the degree of impact made on the project when resources are provided to the project in which the failure occurs, and decide, as resources distributable with higher priority, resources for a project for which the degree of impact is lower.

The output unit 17 outputs information regarding the resources distributable to the project in which the failure occurs based on the excess resources calculated by the calculation unit 16. Specifically, the output unit 17 outputs information regarding the distributable resources decided by the calculation unit 16. For example, the output unit 17 outputs a contribution source of resources and a contribution quantity of resources, the degree of decrease in the service level due to the contribution of resources and a corresponding objective recovery level. Note that more detailed processes of the determination unit 14, the decision unit 15, the calculation unit 16 and the output unit 17 will be described with reference to the processing procedures described below.

[Processing Procedures of Resource Distribution Calculation Device]

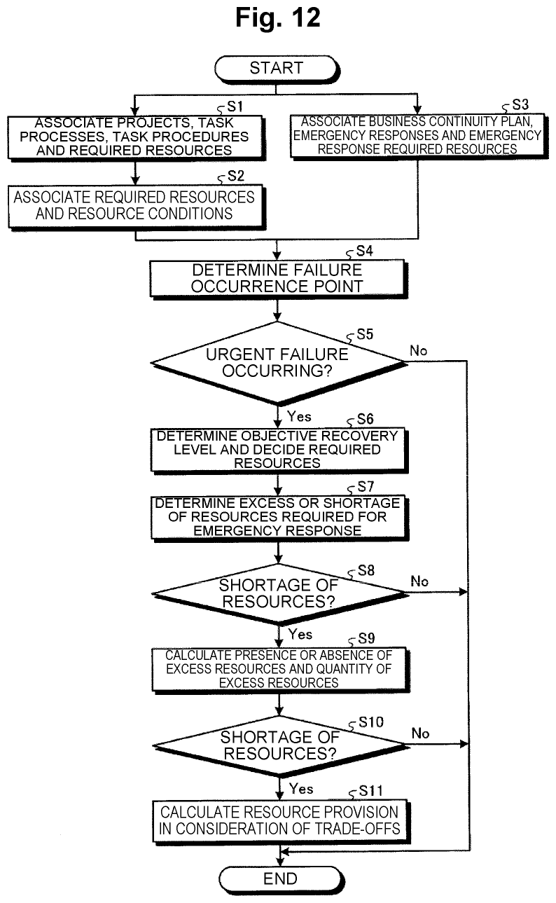

Next, a processing flow of the resource distribution calculation device 10 according to the first embodiment will be described by using FIG. 12. FIG. 12 is a flow chart showing an example processing flow of the resource distribution calculation device according to the first embodiment.

As illustrated in FIG. 12, the association unit 13 of the resource distribution calculation device 10 performs association of projects, task processes, task procedures and required resources (step S1), and then performs association of required resources and resource conditions (step S2). The association unit 13 also performs association of the business continuity plan, emergency responses and emergency response required resources (step S3).

Subsequently, the determination unit 14 determines the point of a failure (step S4). The determination unit 14 then determines whether an urgent failure occurs (step S5). When the determination unit 14 then determines that an urgent failure occurs (Yes in step S5), the process proceeds to step S6. When the determination unit 14 determines that no urgent failure occurs (No in step S5), the process ends immediately.

For more detailed description, the determination unit 14 determines a failure occurrence point by retrieving the resource distribution calculation formula and receiving the result of step 2 and the system log or error log output from the task support system, the abnormality detection log output from the abnormality detection system, or failure information input to the failure event input unit.

It is assumed here that the failure information input to the failure event input unit is information indicating that a resource condition managed in the resource management list is an abnormality. For example, when a failure occurs in task function 4001, failure information thereof is included in the error log of the task support system or the abnormality detection log of the abnormality detection system, and the determination unit 14 thus determines that a failure occurs in task function 4001. Subsequently, the determination unit 14 compares the determination result of the resource condition and the result of step 2 to determine whether a failure of the task procedure, task process and project occurs due to a failure of task function 4001 in a certain period.

For example, when a failure occurs in task function 4001 and there is an operation plan of using task function 4001 for task procedure 2001, the determination unit 14 determines that a failure occurs in the task procedure, task process and project. When there is no operation plan of using task function 4001 for task procedure 2001, the determination unit 14 determines that no failure occurs in the task procedure, task process and project.

In addition, when a failure occurs in task function 4001 and there is no operation plan of using task function 4001 for task procedure 2001, it is certainly necessary to resolve the failure of task function 4001, but it means that such a recovery response is not urgent. In a sense that the present embodiment focuses on how to perform the resource distribution in the case of high urgency and therefore does not deal with response planning of recovery responses and resource distribution with low urgency, the determination unit 14 determines that “no urgent failure occurs”. Note that, when determining that “no urgent failure occurs”, the output unit 17 may output an indication that “a failure occurs although not an urgent failure”.

Returning to the description of S6 in FIG. 12, the decision unit 15 determines the objective recovery level of emergency response and decides required resources (step S6). The decision unit 15 then determines the excess or shortage of resources required for emergency response (step S7).

For more detailed description, the decision unit 15 retrieves the resource distribution calculation formula and receives inputs of the result of step 3 and the determination result of step 4 to determine the objective recovery level and calculate response measures for realizing the objective recovery level, provisional response procedures or recovery procedures as details of the response measure, and emergency response required resources. For example, when a failure occurs in task procedure 2001 and task process 1001 due to a failure in task function 4001 and there are objective recovery level 5101, objective recovery level 5102, . . . in ascending order of the achievement determination criteria of the objective recovery levels, that is, in ascending order of the number of conditions to be satisfied, the decision unit 15 determines that firstly objective recovery level 5101 is a primary objective for recovery since “a failure occurs in task process 1001”. Once the objective recovery level is determined, response measures associated with objective recovery level 5101, provisional response procedures or recovery procedure as details of the response measures, and emergency response required resources are determined from the result of step 3.

Subsequently, the decision unit 15 determines whether there is a shortage of resources required for emergency response (step S8). When the decision unit 15 then determines that there is a shortage of resources required for emergency response (Yes in step S8), the process proceeds to step S9. When the decision unit 15 determines that there is no shortage of resources required for emergency response (No in step S8), the process ends immediately.

The calculation unit 16 then calculates the presence or absence of excess resources and the quantity of excess resources (step S9). The calculation unit 16 then determines the excess or shortage of resources required for emergency response (step S10).

For more detailed description, the calculation unit 16 retrieves the resource distribution calculation formula, and receives the result of step 2, the result of step 6 and the resource management list as inputs to determine the excess or shortage of resources required for emergency response. For example, it is assumed that, when a failure occurs in task procedure 2001, task process 1001 and project 0001 due to a failure in task function 4001, objective recovery level 5101 is defined as a primary objective in the business continuity plan and the provisional response procedure.

It is assumed that provisional response procedure 7101 and provisional response procedure 7202 are defined as alternative means of task procedure 2001 for realizing objective recovery level 5101, and total resources of five persons in total and five hours in total are required, two persons in total and two hours in total for performing provisional response procedure 7101 and three persons in total and three hours in total for performing provisional response procedure 7202.

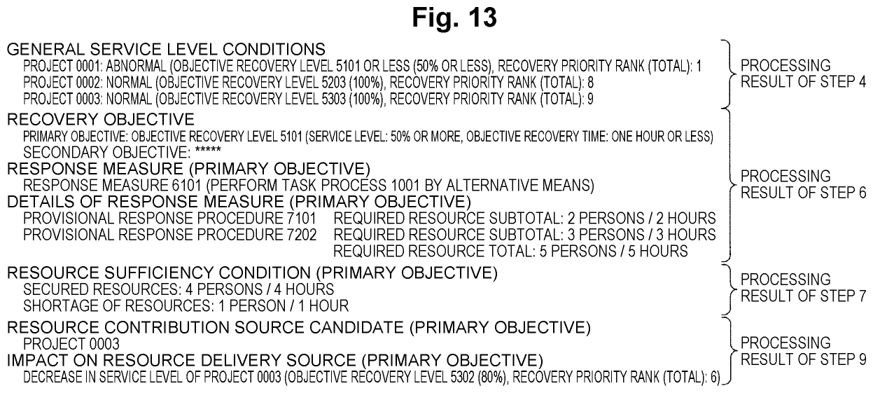

As illustrated in FIG. 13, when the objective recovery time of objective recovery level 5101 is set as one hour or less, five or more personnel are required per hour. Assuming that personnel that perform task procedure 2001 perform provisional response procedure 7101 and provisional response procedure 7202, the number of personnel secured for performing task procedure 2001 is four persons and four hours with reference to the resource management list, and therefore the calculation unit 16 determines that there is a shortage of resources by one person and one hour.

When determining that there is a shortage of resources (Yes in step S10), the calculation unit 16 calculates a resource provision in consideration of trade-offs (step S11). Note that, when the calculation unit 16 determines that there is a shortage of resources (No in step S10), the process ends immediately.

For more detailed description, the calculation unit 16 calculates a contribution source and a contribution quantity of resources insufficient to perform the emergency response in step S11. The calculation unit 16 retrieves the resource distribution calculation formula, and receives the determination result of step 7, the result of step 2, the determination result of step 4, the resource management list and the business continuity plan as inputs to calculate the contribution source of resources and the contribution quantity of resources for supplementing the insufficient resources. An example of the processing order of calculation will be shown by (1) and (2) below.

(1) Determination of Presence or Absence of Excess Resources and Quantity of Excess Resources

In the present embodiment, regarding the contribution source of resources, resources are contributed with higher priority from a point having excess resources, if any. Regarding the determination of whether there are excess resources and the calculation of the quantity of contributable resources, the calculation unit 16 performs the determination and calculation based on the resource management list. First, the calculation unit 16 compares the result of step 4 and the result of step 2 to extract projects, task processes and task procedures in which no failure occurs. Next, the calculation unit 16 references the resource management list associated with these, determines the presence or absence of excess resources by using the remaining number of required resources in a certain period, the number of secured resources and the period (completion deadline) of a task procedure or the like, and calculates the quantity of excess resources.

For example, when four hours (240 minutes) are left before the completion deadline of task procedure 2101 associated with project 0002, the remaining number of performances planned is 60, and resources of one person/time and each tool (task function 4001, task function 4002, task function 4003, the budget control list) and five minutes/time are required, the remaining number of required resources is 60 persons and 300 minutes in total. Note that it is assumed that the tools used for task procedure 2101 all have sufficiently short resource reuse cycles, and therefore the total number of usages and associated usage time can be ignored as long as the tool is available.

If five personnel are secured at this time, from a calculation of 60 (times)/5 (persons)=12 (times/person), the planned number of times of task procedure 2101 can be completed by performing 12 times one person, and can be completed in 5 minutes/time×12 times=60 minutes if all persons perform it at the same time. For example, the minimum number of persons X required for meeting the completion deadline is obtained by solving (total time: 300 minutes)/X≤(remaining time before the completion deadline: 240 minutes), and X=1.25 persons. Alternatively, since the required time per time is five minutes, the number of performances per minute is 1/5=0.2, and the minimum number of persons X required for meeting the completion deadline is similarly obtained as X=1.25 persons by solving (the number of performances per minute: 0.2 times/minute)×(remaining time before the completion deadline: 240 minutes)×X≥(the remaining number of performances: 60 times).

From these calculations, for example, since X=1.25 persons=(1+0.25) persons out of five personnel secured for task procedure 2101, the calculation unit 16 can calculate that it takes 240 minutes for one person to perform task procedure 2101, one person is in charge of task procedure 2101 for 240×0.25=60 minutes and can contribute resources for the remaining 180 minutes, and the remaining three persons are resources that can be contributed during all 240 minutes. Therefore, personnel and time contributable from task procedure 2101 are 3.75 persons and 3.75 hours. When resources are short by one person and one hour to perform provisional response procedure 7101 and provisional response procedure 7202 based on the determination result of step 7, contributable resources (3.75 persons and 3.75 hours)>required resources (one person and one hour), and therefore the calculation unit 16 calculates that the insufficient resources required to perform provisional response procedure 7101 and provisional response procedure 7202 can be contributed and supplemented without lowering the service level of task procedure 2210.

When there are a plurality of points having excess resources, the resource distribution calculation device 10 may decide the rank of contribution sources and how to distribute contribution quantities in a desired manner. For example, the resource distribution calculation device 10 may contribute resources from a point with a larger quantity of excess resources than others until it becomes approximately the same as the quantities of excess resources of the others, and contribute resources from another point with a quantity of excess resources according to a certain rule if there is still a shortage of resources required to perform emergency response.

In addition, for example, the resource distribution calculation device 10 may predetermine a point from which resources are contributed with higher priority until excess resources run out and contribute resources with higher priority from there, and contribute resources according to a certain rule from another point with a quantity of excess resources if there is still a shortage of resources required to perform emergency response when the excess resources that can be contributed from the point run out.

(2) Calculation of Resource Provision in Consideration of Trade-Offs

In the present embodiment, regarding the contribution source of resources and the contribution quantity of resources in the case of no excess resources, resources are contributed with higher priority from a point with a lower degree of impact on the project due to decrease in the service level caused by the contribution of resources. First, the calculation unit 16 compares the result of step 4 and the result of step 2 to extract projects, task processes and task procedures in which no failure occurs. Next, the calculation unit 16 references the resource management list associated with these and calculates impacts made on the task procedure, task process and project in case that the remaining number of required resources falls short.

For example, when four hours (240 minutes) are left before the completion deadline of task procedure 2211 associated with project 0003, the remaining number of performances planned is 60, and resources of one person/time and 20 minutes/time are required per time, the remaining number of required resources is 60 persons and 1200 minutes in total. The minimum number of persons Y required to meet the completion deadline is obtained by solving 1200/Y≤240, and Y=5 persons. Since the number of performances per person and per hour is 60 (minutes)/20 (minutes/time)=3 times, the number of performances of task procedure 2211 is decreased by three times per hour every time a shortage of one person from five persons occurs. Subsequently, the calculation unit 16 references the business continuity plan and determines which of objective recovery levels in the case of occurrence of an incident in project 0003 the degree of decrease in the service level corresponds to.

For example, it is assumed that project 0003 includes task process 1201 and the task process includes task procedure 2211. When it is known from an analysis of the budget control list that project 0003 achieves five hundred thousand yen per day by performing task procedure 2211 sixty times per day, if the lacking resources of one person and one hour, required to perform provisional response procedure 7101 and provisional response procedure 7202, are contributed from task procedure 2211, three times of performing task procedure 2211 are lost, and therefore, from a calculation of 3 times/60 times=0.05, the sales decreases by 5%.

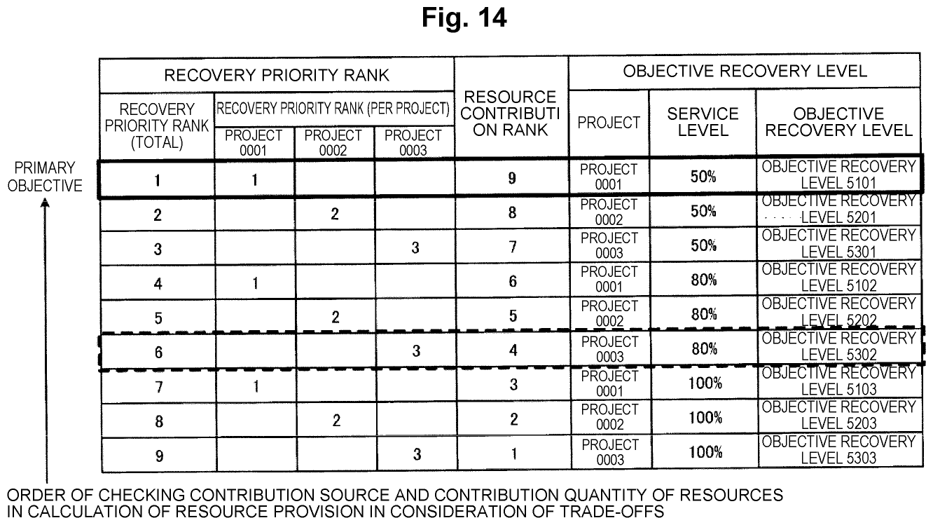

The calculation unit 16 determines which of objective recovery levels in the case of occurrence of an incident in project 0003 the service level with this 5% decrease in the sales corresponds to. Assuming that objective recovery levels are defined as 50%, 80% and 100% in a stepwise manner in the business continuity plan, the calculation unit 16 determines that, since 100−5=95%, the service level corresponds to “80%” in a sense that it reaches the minimum level. That is, as illustrated in FIG. 14, when resources of project 0003 are provided, the recovery priority rank of project 0003 becomes “6” due to decrease in the service level. The calculation unit 16 performs calculation of the degree of decrease in the service level when the required resources fall short and a corresponding objective recovery level for all projects, task processes and task procedures in which no failure occurs.

Subsequently, the calculation unit 16 compares the degree of decrease in the service level when the required resources fall short and an absolute or relative priority of each objective recovery level of each project described in the business continuity plan to determine to contribute resources in the order from one that corresponds to an objective recovery level with a lower degree of decrease in the service level when the required resources fall short.

That is, in the example of FIG. 14, since the recovery priority rank of project 0003 becomes “6” due to decrease in the service level, the degree of decrease in the service level when the required resources fall short is lower than that of another project 0002, the recovery priority rank of the primary objective is “1”, and the priority of the primary objective is higher, the calculation unit 16 determines to contribute resources of project 0003. Note that, when the priority of the objective recovery level corresponding to the degree of decrease in the service level due to contribution of resources from a certain point is higher than the objective recovery level, it is determined that the contribution of resources from the point is not to be performed.

After the processes of the flow chart of FIG. 12 ends, the output unit 17 outputs the result of resource distribution calculation to step S11 in the form of a table or the like. The output unit 17 also outputs a failure occurrence point and task procedures, task processes and projects affected by the occurrence of the failure based on the determination result of step 4.

Note that the process of step S4 may be returned to repeat the process after the processes of the flow chart of FIG. 12 ends. That is, by repeating the processes of the flow chart, the resource distribution calculation device 10 can calculate appropriate distribution of resources in accordance with the failure occurrence condition and resource recovery condition at each time.

The output unit 17 also outputs objective recovery levels and objective recovery times, response measures, provisional response procedures or recovery procedures as details of the response measures and emergency response required resources based on the determination result of step 6. The output unit 17 also outputs whether there are sufficient resources required to perform the provisional response procedures or recovery procedures and, if not, the quantity of shortage based on the determination result of step 7.

The output unit 17 also outputs the contribution source of resources and the contribution quantity of resources, the degree of decrease in the service level due to the contribution of resources and a corresponding objective recovery level based on the determination result of step S11.

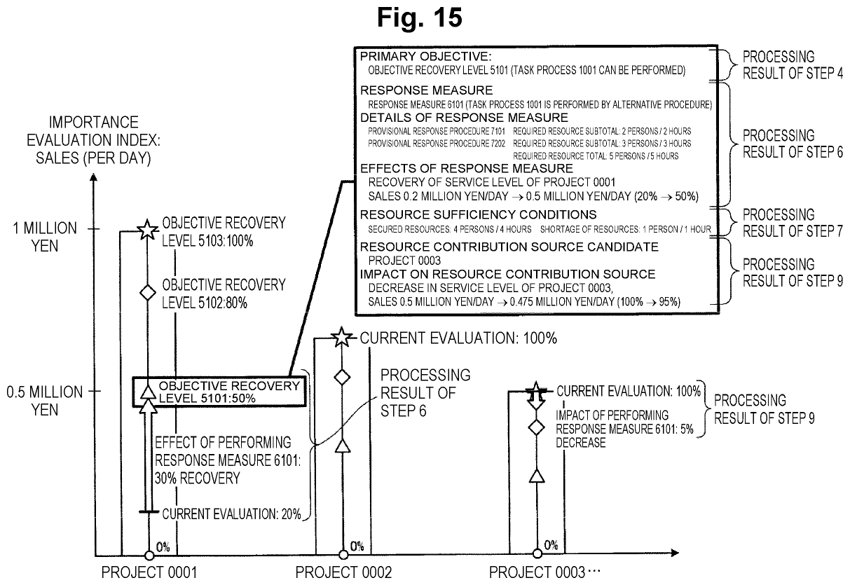

For example, as illustrated in FIG. 13, the output unit 17 may output general service level conditions, recovery objectives, response measures, details of the response measures, resource sufficiency conditions, resource contribution source candidates and impacts on resource delivery sources. In addition, for example, as illustrated in FIG. 14, the output unit 17 may output recovery priority ranks, resource contribution ranks and objective recovery levels in the form of a table. In addition, for example, as illustrated in FIG. 15, the output unit 17 may display current evaluations, objective recovery levels and the like of the projects in the form of a graph.

By outputting these results of resource distribution calculation, a user of the resource distribution calculation device 10 can effectively recognize how to secure resources required to perform response measures at the time of occurrence of an incident.

That is, the resource distribution calculation device 10 quickly and accurately determines the failure occurrence point and impacts on task procedures, task processes and projects due to the failure based on the logs of the task support system N_{S} and the abnormality detection system N_{A}, the failure information on the failure event manually input and the budget control list. In addition, the resource distribution calculation device 10 presents details of response measures for realizing the objective recovery level, resources required to perform the response measures and the contribution source of resources and the contribution quantity of resources based on the business continuity plan, the recovery procedure, the provisional response procedure and the resource management list. In this manner, the user of the resource distribution calculation device 10 can effectively distribute resources in the organization while minimizing decrease in the service level for the organization as a whole at the time of occurrence of an incident.

In addition, the user of the resource distribution calculation device 10 can effectively recognize the priority order of response measures and how to secure resources required to perform the response measures even when a plurality of incidents occur simultaneously. That is, when a failure occurs in one or more points of task functions, which are components of each project, in one or more projects and one or more task processes and task procedures cannot be performed, the resource distribution calculation device 10 can determine the priority order of response measures based on the priority order of objective recovery levels and present resources required to perform response measures for achieving the objective recovery level, the contribution source of resources and the contribution quantity of resources.

Further, the user of the resource distribution calculation device 10 can simulate response measures at stepwise objective recovery levels at the time of occurrence of an incident and how to secure resources required to perform the response measures by using steps S1 to S11 of the flow chart mentioned above.

For example, it is assumed that the first target recovery is “objective recovery level 5001” and the next target recovery after achieving this is “objective recovery level 5002”. To recognize in advance and prepare resources required to smoothly perform “objective recovery level 5002”, the user of the resource distribution calculation device 10 can check provisional response procedures or recovery procedures as response measures for “objective recovery level 5002”, resources required to perform the response measures, the contribution source of resources and the contribution quantity of resources.

Note that this simulation may be automatically performed by the resource distribution calculation device 10, or situations that reach “objective recovery level 5001” may be input to the failure event input unit 12 so that resources required to realize “objective recovery level 5002”, the contribution source of resources and the contribution quantity of resources are presented.

The processes of steps S1 to S8 described above may be performed at the time of occurrence of an incident, or may be performed at different times. For example, a method may be adopted in which steps S1 to S3 are performed at desired timings in normal times, results are held in an internal recording device or external recording device of the resource distribution calculation system, and the results of step S2 and step S3 are read from the storage unit 18 at the time of performing steps S4 to S11. In addition, the resource distribution calculation device 10 may be used to consider the response measures at the time of occurrence of an incident, or may be used to formulate or modify the business continuity plan.

[Effects of First Embodiment]

The resource distribution calculation device 10 according to the first embodiment decides resources required to recover a project in which a failure occurs, calculates the quantity of excess resources for another project in which no failure occurs, and outputs information regarding excess resources distributable to the project in which the failure occurs based on the calculated excess resources. In this manner, the resource distribution calculation device 10 can appropriately distribute resources when an incident occurs.

When an incident occurs, the resource distribution calculation device 10 according to the first embodiment can compare a damage condition of the incident, an objective recovery level and the degree of impact on the project and effectively distribute resources in order to support appropriately distributing resources among damaged tasks and tasks not damaged.

That is, since only limited resources are available to the organization, it may be necessary to rent resources assigned to a task that is not damaged due to the occurrence of the incident in order to achieve the objective recovery time and the objective recovery level. If a choice of lending resources is made in this case, a trade-off occurs in which the objective recovery time and the objective recovery level can be achieved whereas the service level of the task for which resources are lent is decreased.

To reduce such a trade-off as possible, it is desirable to contribute resources with higher priority from a task having excess resources over the quantity required to realize a normal service level and, if resources must be contributed even while falling below the normal service level, adjust the contribution source of resources and the contribution quantity of resources such that the degree of impact on the project is reduced as possible for the organization as a whole.

Thus, when an incident occurs, the resource distribution calculation device 10 according to the first embodiment can compare a damage condition of the incident, an objective recovery level and the degree of impact on the project and effectively distribute resources in order to support appropriately distributing resources among damaged tasks and tasks not damaged.

(System Configuration, etc.)

In addition, the components of the devices illustrated are functionally conceptualized and not necessarily physically configured as illustrated. That is, the specific form of distribution and integration of the devices is not limited to that illustrated, and all or part of them can be functionally or physically distributed or integrated in desired units according to various loads, usage conditions and the like. Further, all or desired part of the processing functions performed by the devices can be realized by a CPU and a program analyzed and executed by the CPU, or realized as hardware with wired logic.

In addition, all or part of the processes described as being automatically performed in the present embodiment can be manually performed, or all or part of the processes described as being manually performed can be automatically performed in known methods. Additionally, processing procedures, control procedures, specific names, information including various pieces of data and parameters shown in the above text and the drawings can be modified as desired unless specified otherwise.

(Program)

It is also possible to create a program in which processes performed by the resource distribution calculation device described in the above-described embodiment are described in a computer-executable language. For example, it is also possible to create a resource distribution calculation program in which processes performed by the resource distribution calculation device 10 according to the embodiment are described in a computer-executable language. In this case, the computer can execute the resource distribution calculation program to obtain similar effects as in the above-described embodiment. Further, similar processes as in the above-described embodiment may be realized by recording the resource distribution calculation program on a computer-readable recording medium and causing the computer to read and execute the resource distribution calculation program recorded on the recording medium.

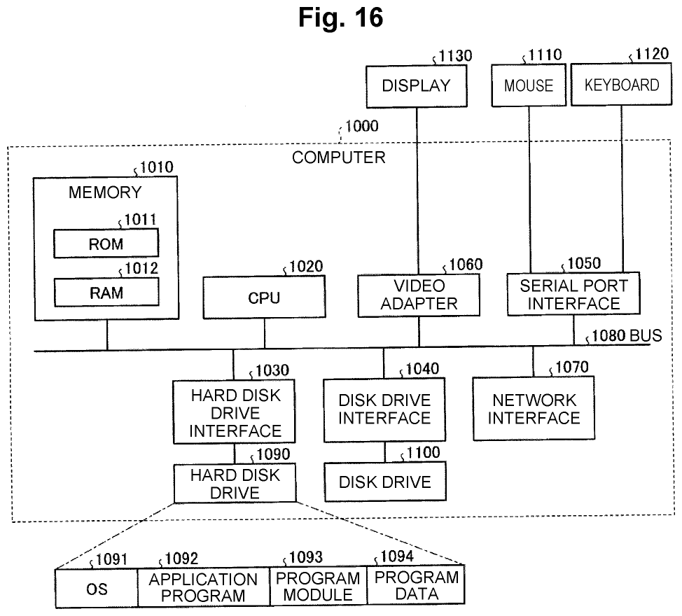

FIG. 16 is a diagram showing a computer that executes a resource distribution calculation program. As illustrated in FIG. 16, for example, a computer 1000 includes a memory 1010, a CPU 1020, a hard disk drive interface 1030, a disk drive interface 1040, a serial port interface 1050, a video adapter 1060 and a network interface 1070, and these components are connected by a bus 1080.

As illustrated in FIG. 16, the memory 1010 includes a read only memory (ROM) 1011 and a RAM 1012. For example, the ROM 1011 stores a boot program such as a basic input output system (BIOS). The hard disk drive interface 1030 is connected to a hard disk drive 1090 as illustrated in FIG. 16. The disk drive interface 1040 is connected to a disk drive 1100 as illustrated in FIG. 16. For example, a removable storage medium such as a magnetic disk or an optical disc is inserted into the disk drive 1100. The serial port interface 1050 is connected to a mouse 1110 and a keyboard 1120, for example, as illustrated in FIG. 16. The video adapter 1060 is connected to a display 1130, for example, as illustrated in FIG. 16.

Here, as illustrated in FIG. 16, the hard disk drive 1090 stores an OS 1091, an application program 1092, a program module 1093 and program data 1094, for example. That is, the resource distribution calculation program described above is stored in the hard disk drive 1090, for example, as a program module in which commands executed by the computer 1000 are described.

In addition, various pieces of data described in the above-described embodiment are stored in the memory 1010 and the hard disk drive 1090, for example, as program data. Then, the CPU 1020 reads the program module 1093 and the program data 1094 stored in the memory 1010 and the hard disk drive 1090 on the RAM 1012 as needed and performs various processing procedures.

Note that the program module 1093 and the program data 1094 for the resource distribution calculation program are not necessarily stored in the hard disk drive 1090, and may be stored in a removable storage medium, for example, and read by the CPU 1020 via a disk drive or the like. Alternatively, the program module 1093 and the program data 1094 for the resource distribution calculation program may be stored in another computer connected via a network (such as a local area network (LAN) or a wide area network (WAN)) and read by the CPU 1020 via the network interface 1070.

### REFERENCE SIGNS LIST

10 Resource distribution calculation device

11 External data input unit

12 Failure event input unit

13 Association unit

14 Determination unit

15 Decision unit

16 Calculation unit

17 Output unit

18 Storage unit

1. A resource distribution calculation device comprising a processor configured to execute a method comprising:
determining resources needed to recover a project in which a failure occurs;
calculating a quantity of excess resources for another project in which no failure occurs; and
outputting information regarding resources distributable to the project in which the failure occurs based on the excess resources.

2. The resource distribution calculation device according to claim 1, wherein
when there are a plurality of other projects in which no failure occurs, the calculating further comprises calculating the quantity of excess resources for each of the plurality of other projects, and determining, as resources distributable with higher priority, the excess resources for another project with a largest quantity of excess resources of the calculated excess resources, and
the outputting further comprises outputting information regarding the determined resources.

3. The resource distribution calculation device according to claim 1, wherein
when there is no excess resource for the other project, the calculating further comprises:
calculating, for one or more of other projects without a failure occurring, a degree of impact made on the project when resources are provided to the project in which the failure occurs,
determining, as resources distributable with higher priority, resources for a project for which the degree of impact is lower, and
outputting information regarding the resources.

4. The resource distribution calculation device according to claim 1, the processor further configured to execute a method comprising:
determining a project in which a failure occurs, and
determining resources needed to recover the determined project in which the failure occurs.

5. A computer implemented method for calculating resource distribution, comprising:
determining resources needed to recover a project in which a failure occurs;
calculating a quantity of excess resources for another project in which no failure occurs; and
outputting information regarding resources distributable to the project in which the failure occurs based on the excess resources calculated in the calculation process.

6. A computer-readable non-transitory recording medium storing a computer-executable program instructions that when executed by a processor cause a computer to execute a method comprising:
determining resources needed to recover a project in which a failure occurs;
calculating a quantity of excess resources for another project in which no failure occurs; and
outputting information regarding resources distributable to the project in which the failure occurs based on the excess resources calculated.

7. The resource distribution calculation device according to claim 1, wherein the failure includes a natural disaster causing a damage in the resource in need.

8. The resource distribution calculation device according to claim 1, wherein the resource includes at least one of: a personnel, a tool for performing a task in the project, or a time.

9. The resource distribution calculation device according to claim 1, wherein the resource needed includes one or more of the following:
a task procedure that needs the resource,
a resource classification,
a resource name,
a number of needed resources, and
a resource reuse cycle.

10. The computer implemented method according to claim 5,
wherein
when there are a plurality of other projects in which no failure occurs, the calculating further comprises calculating the quantity of excess resources for each of the plurality of other projects, and determining, as resources distributable with higher priority, the excess resources for another project with a largest quantity of excess resources of the calculated excess resources, and
the outputting further comprises outputting information regarding the determined resources.

11. The computer implemented method according to claim 5,
wherein
when there is no excess resource for the other project, the calculating further comprises:
calculating, for one or more of other projects without a failure occurring, a degree of impact made on the project when resources are provided to the project in which the failure occurs,
determining, as resources distributable with higher priority, resources for a project for which the degree of impact is lower, and
outputting information regarding the resources.

12. The computer implemented method according to claim 5, further comprising:
determining the project in which a failure occurs; and
determining the resources needed to recover the determined project in which the failure occurs.

13. The computer implemented method according to claim 5, wherein the failure includes a natural disaster causing a damage in the resource in need.

14. The computer implemented method according to claim 5, wherein the resource includes at least one of: a personnel, a tool for performing a task in the project, or a time.

15. The computer implemented method according to claim 5, wherein the resource needed includes at least one of:
a task procedure that needs the resource,
a resource classification,
a resource name,
a number of needed resources, and
a resource reuse cycle.

16. The computer-readable non-transitory recording medium according to claim 6, wherein
when there are a plurality of other projects in which no failure occurs, the calculating further comprises calculating the quantity of excess resources for each of the plurality of other projects, and determining, as resources distributable with higher priority, the excess resources for another project with a largest quantity of excess resources of the calculated excess resources, and
the outputting further comprises outputting information regarding the determined resources.

17. The computer-readable non-transitory recording medium according to claim 6, wherein
when there is no excess resource for the other project, the calculating further comprises:
calculating, for one or more of other projects without a failure occurring, a degree of impact made on the project when resources are provided to the project in which the failure occurs,
determining, as resources distributable with higher priority, resources for a project for which the degree of impact is lower, and
outputting information regarding the resources.

18. The computer-readable non-transitory recording medium according to claim 6, the computer-executable program instructions when executed further causing the computer to execute a method comprising:
determining the project in which a failure occurs; and
determining the resources needed to recover the determined project in which the failure occurs.

19. The computer-readable non-transitory recording medium according to claim 6, wherein the failure includes a natural disaster causing a damage in the resource in need, and
wherein the resource includes at least one of: a personnel, a tool for performing a task in the project, or a time.

20. The computer-readable non-transitory recording medium according to claim 6,
wherein the resource needed includes at least at least one of:
a task procedure that needs the resource,
a resource classification,
a resource name,
a number of needed resources, and
a resource reuse cycle.
